(19) United States
(12) Patent Application Publication
(10) Pub. No.: US 2016/0372268 A1
(43) Pub. Date: Dec. 22, 2016

(54) CAPACITOR ANODE AND PRODUCTION METHOD FOR SAME

(71) Applicant: SHOWA DENKO K.K., Tokyo (JP)

(72) Inventors: Kazumi NAITO, Minato-ku, Tokyo (JP); Shoji YABE, Minato-ku, Tokyo (JP)

(73) Assignee: SHOWA DENKO K.K., Minato-ku, Tokyo (JP)

(21) Appl. No.: 14/898,792

(22) PCT Filed: Jun. 13, 2014
(86) PCT No.: PCT/JP2014/065728

§ 371 Date: Dec. 16, 2015

(30) Foreign Application Priority Data
Jun. 18, 2013 (JP) 2013-128000

(51) Int. Cl. H01G 9/052; H01G 9/042; H01G 9/00

(52) U.S. Cl. CPC H01G 9/0525; H01G 9/0029; H01G 9/042

(57) ABSTRACT

An anode body for a capacitor and method for producing the same, which method includes compressing a powder mixture containing a tungsten powder and a high-oxygen-affinity metal powder into a compact with a wire rod planted therein, and firing the compact into a sintered compact. The high-oxygen-affinity metal has an oxygen affinity higher than that of tungsten. The content of the high-oxygen-affinity metal powder in the powder mixture is regulated so that the content of the high-oxygen-affinity metal in the sintered compact is 0.1 to 3% by mass based on the mass of the tungsten in the sintered compact. The wire rod includes tantalum or niobium. Also disclosed is an electrolytic capacitor including the anode body.

### TECHNICAL FIELD

The present invention relates to an anode body for a capacitor and a method for producing the anode body. More specifically, the present invention relates to an anode body for a capacitor in which the base of an implanted wire rod is free from somberness and the wire rod is hardly broken and relates to a method for producing the anode body.

### BACKGROUND ART

An electrolytic capacitor using an anode body composed of a sintered compact of a tungsten powder is known (Patent Document 2). The electrolytic capacitor using the anode body composed of the sintered compact of a tungsten powder can have a large capacity, compared to an electrolytic capacitor produced by chemical conversion of an anode body that is made of a tantalum powder having the same particle diameter as that of the tungsten powder and has the same volume as that of the anode body of the tungsten powder at the same chemical conversion voltage as for that of the tungsten powder. In general, a lead wire is planted in the sintered compact to be used as an anode. The lead wire to be used is generally a wire rod comprising tantalum or niobium.

### CITATION LIST

### Patent Literatures

Patent Document 1: JP 2001-307963 A

Patent Document 2: WO 2012/86272 A

### Non-Patent Literatures

Non-Patent Document 1: The Oxide HandBook, G. V. Samsonov, IFI/Plenum, 1973, pp. 85-86

### SUMMARY OF THE INVENTION

### Problems to be Resolved by the Invention

In the tungsten powder sintered compact planted with such a wire rod, however, some reaction occurred during firing may cause somberness at the base of the implanted wire rod or readily break the wire rod to reduce the production yield. Such a phenomenon does not occur in the sintered compact of a tantalum powder or niobium powder.

An object of the present invention is to provide an anode body for a capacitor in which an implanted wire rod is hardly broken and a method for producing the anode body.

### Means for Solving the Problems

The inventors have intensively studied in order to achieve the above-mentioned object and have accomplished the present invention encompassing the following aspects.

[1] An anode body for a capacitor, the anode body comprising:
a sintered compact comprising tungsten and a high-oxygen-affinity metal; and
a wire rod partially embedded in the sintered compact, wherein
the high-oxygen-affinity metal has an oxygen affinity higher than that of tungsten, the content of the high-oxygen-affinity metal in the sintered compact is 0.1 to 3% by mass based on the mass of the tungsten in the sintered compact; and
the wire rod comprises tantalum or niobium.

[2] The anode body according to aspect [1], wherein the high-oxygen-affinity metal is a valve action metal.

[3] The anode body according to aspect [1] or [2], wherein the high-oxygen-affinity metal is at least one selected from the group consisting of tantalum, niobium, titanium, and aluminum.

[4] The anode body according to any one of aspects [1] to [3], wherein the sintered compact further comprises silicon.

[5] The anode body according to aspect [4], wherein the amount of the silicon in the sintered compact is 0.05 to 7% by mass based on the mass of the tungsten in the sintered.

[6] A method for producing an anode body for a capacitor, the method comprising:
compressing a powder mixture comprising a tungsten powder and a high-oxygen-affinity metal powder into a compact with a wire rod planted therein; and
firing the compact into a sintered compact, wherein the high-oxygen-affinity metal has an oxygen affinity higher than that of tungsten;
the content of the high-oxygen-affinity metal powder in the powder mixture is regulated so that the content of the high-oxygen-affinity metal in the sintered compact is compact0.1 to 3% by mass based on the mass of the tungsten in the sintered compact; and
the wire rod composes tantalum or niobium.

[7] The method for producing the anode body according to aspect [6], wherein the powder mixture further comprises a silicon powder.

[8] The method for producing the anode body according to aspect [6] or [7], wherein the high-oxygen-affinity metal powder has an oxygen content of not more than 3% by mass.

[9] The method for producing the anode body according to any one of aspects [6] to [8], wherein the high-oxygen-affinity metal powder has an average primary particle diameter twice or less that of the tungsten powder.

[10] The method for producing the anode body according to any one of aspects [6] to [9], wherein the powder mixture is prepared by mixing a granulated high-oxygen-affinity metal powder prepared by firing and pulverizing the high-oxygen-affinity metal powder and a granulated tungsten powder prepared by firing and pulverizing the tungsten powder; and
the granulated high-oxygen-affinity metal powder has a particle size distribution range within a range of the particle size distribution of the granulated tungsten powder; or
the granulated high-oxygen-affinity metal powder has a maximum particle diameter twice or less that of the granulated tungsten powder.

[11] A capacitor comprising the anode body according to any one of aspects [1] to [5].

### Advantageous Effects of the Invention

It is generally believed that a wire rod made of tantalum or niobium can be prevented from being broken by increasing the diameter of the wire rod or forming a deposition film on the surface of the wire rod. An increase in the diameter of the wire rod or the formation of a deposition film, however, not only raises the production cost but also increases the volume of the wire rod in the anode body to reduce the capacity of the electrolytic capacitor.

In contrast, in the anode body according to the present invention, the implanted wire rod is hardly broken even if the diameter of the wire rod is not increased or no deposition film is formed. The production method according to the present invention certainly makes the implanted wire rod to be hardly broken at low cost.

### EMBODIMENTS FOR CARRYING OUT THE INVENTION

The anode body according to an embodiment of the present invention comprises a sintered compact comprising tungsten and a high-oxygen-affinity metal and a wire rod partially embedded in the sintered compact. The sintered compact is prepared by firing a powder mixture comprising a tungsten powder and a high-oxygen-affinity metal powder.

The tungsten powder used for preparing the sintered compact is a tungsten metal powder. The tungsten powder may be obtained by any method. For example, a solid tungsten metal is commercially available in a powder form, and such a commercial product is usable. A tungsten powder having a desired particle diameter can be prepared by pulverizing a tungsten trioxide powder in a hydrogen gas flow by setting various conditions. A tungsten powder can also be prepared by reducing tungstic acid or halogenated tungsten with a reducing agent such as hydrogen, sodium or the like. Alternatively, a tungsten powder can be prepared from a tungsten-containing mineral directly or through a plurality of steps.

The tungsten powder, a raw material used in the present invention, has an oxygen content of preferably 0.05 to 8% by mass, more preferably 0.08 to 1% by mass, and still more preferably 0.1 to 1% by mass.

The tungsten powder may have surfaces at least partially borided, phosphided, and/or carbonized or may be a mixture containing at least one of such tungsten powders. Tungsten powder and a mixture thereof may contain nitrogen in at least a part of the surface.

The tungsten powder has an average primary particle diameter of preferably 0.1 to 1 μm, more preferably 0.1 to 0.7 μm, and still more preferably 0.1 to 0.3 μm. The tungsten powder may be a granulated powder. A granulated tungsten powder can be produced by, for example, firing and pulverizing a tungsten powder. The granulated powder may be produced by, for example, firing and pulverizing a once produced granulated powder again. The range of the particle diameters of the granulated tungsten powder may be regulated by, for example, sieving, and is within preferably 20 to 170 μm and more preferably 26 to 140 μm. The granulated tungsten powder used in the present invention is preferably a porous powder prepared by sintering a nongranulated tungsten powder.

The high-oxygen-affinity metal used in the sintered compact has an oxygen affinity higher than that of tungsten. Whether a metal has a high oxygen affinity can be determined from the free energy of formation of an oxide of the metal. Since the free energies of formation of Ta₂O₅, Nb₂O₅, Al₂O₃, TiO₂, and WO₃ at 298K are respectively −1970, −1770, −1580, −882, and −763 (×10⁻⁶ J/kg/mol), tantalum, niobium, aluminum, titanium, and tungsten are easily oxidized in this order (Non-Patent Document 1).

In addition, the oxide of the high-oxygen-affinity metal used in the sintered compact is preferably chemically stable in the environment in which the anode body is used. Accordingly, the high-oxygen-affinity metal is desirably a valve action metal that forms a stable oxide film. Such a valve action metal is preferably at least one selected from the group consisting of tantalum, niobium, titanium, and aluminum, more preferably tantalum or niobium, and most preferably tantalum.

The high-oxygen-affinity metal powder has an oxygen content of preferably not more than 3% by mass and more preferably not more than 2% by mass. The use of a high-oxygen-affinity metal powder having a lower content of oxygen further prevents the implanted wire rod from being broken.

The high-oxygen-affinity metal powder has an average primary particle diameter preferably twice or less and more preferably equal or less to that of the tungsten powder. The average primary particle diameter in the present invention is the value obtained by measuring the particle diameters of about 10 to 30 primary particles randomly selected from an image taken with a scanning electron microscope (SEM) at a magnification of 100000 times and averaging the measured values based on the number. That is, the average primary particle diameter is a number-average primary particle diameter. The accuracy of the number-average primary particle diameter can be increased by observing and measuring for a larger number of primary particles to determine the average of the diameters thereof.

The high-oxygen-affinity metal powder may be a granulated powder. The granulated high-oxygen-affinity metal powder can be produced by, for example, firing and pulverizing the high-oxygen-affinity metal powder or may be produced by, for example, firing and pulverizing a once produced granulated powder again. The granulated high-oxygen-affinity metal powder that is used in the present invention is preferably a porous powder prepared by sintering a nongranulated high-oxygen-affinity metal powder.

The granulated high-oxygen-affinity metal powder preferably has a particle size distribution range within a range of the particle size distribution of the granulated tungsten powder, or preferably has a maximum particle diameter twice or less that of the granulated tungsten powder. In the present invention, the particle diameters and particle size distribution of a granulated powder can be determined by sieving.

The amount of the high-oxygen-affinity metal is 0.1 to 3% by mass, preferably 0.5 to 3% by mass, and more preferably 1 to 3% by mass, based on the mass of tungsten in the sintered compact.

The sintered compact according to the present invention may further comprise silicon. A silicon powder is preferably used for preparing the sintered compact comprising silicon. When a powder mixture comprising a tungsten powder and a high-oxygen-affinity metal powder is prepared, the silicon powder is preferably added thereto. The silicon powder preferably has almost the same number-average primary particle diameter as that of the tungsten powder. The amount of silicon in the sintered compact is preferably 0.05 to 7% by mass, more preferably 0.1 to 3% by mass, based on the mass of tungsten in the sintered compact.

The wire rod used in the present invention comprises tantalum or niobium. The wire rod may contain impurities within a range that does not impair the effects of the present invention, in addition to tantalum or niobium. The impurities may be an alloy element forming an alloy with tantalum or niobium. The wire rod may have a circular cross section or a thin elliptic or rectangular cross section (foil). The wire rod is implanted in a compact of a powder mixture by, for example, embedding it in the powder mixture when it is compressed. The wire rod is used as the anode lead wire of a capacitor anode body.

The anode body for a capacitor according to an embodiment of the present invention can be produced by, for example, as follows.

First, a tungsten powder, a high-oxygen-affinity metal powder and optionally a silicon powder are mixed to obtain a powder mixture comprising them. On this occasion, the amount of the high-oxygen-affinity metal powder in the powder mixture is regulated so that the content of the high-oxygen-affinity metal in the sintered compact is 0.1 to 3% by mass based on the mass of the tungsten in the sintered compact. Since the mass ratio between the tungsten and the high-oxygen-affinity metal in the sintered compact is approximately the same as that in the powder mixture, the amount of the high-oxygen-affinity metal powder in the powder mixture may be regulated using the above-mentioned range as a guide. Secondly, the powder mixture is compressed to form a compact. In order to easily perform the compress-forming, a binder may be added to the powder mixture. Various conditions, such as powder amounts, pressure or the like, can be appropriately determined to give, for example, a desired forming density. The wire rod is planted when the powder mixture is compressed. The compact implanted with the wire rod is then fired.

The temperature during the firing is preferably 1000° C. to 1700° C. and more preferably 1300° C. to 1600° C. The firing time is preferably 10 to 50 minutes and more preferably 15 to 30 minutes. In these ranges, spaces (pores) in the powder mixture can be maintained, and a sintered compact having a sufficient strength can be readily prepared. The firing may be performed in any atmosphere and is preferably performed in an atmosphere of an inert gas such as argon, helium or the like, or in a reduced pressure. In addition, boriding, phosphiding, or carbonizing described above and/or addition of nitrogen may be performed during the firing.

In conventional anode bodies, the wire rod made of tantalum, niobium or an alloy thereof and implanted in a sintered compact of a tungsten powder may have somberness and may be easily broken. Analysis of a cross section of the wire rod having somberness by X-ray photoelectron spectroscopy (XPS) demonstrates that the somberness is a thick layer of tantalum oxide or niobium oxide formed on the surface of the wire rod.

Since tantalum or niobium constituting the wire rod has an oxygen affinity higher than that of tungsten constituting the sintered compact, oxygen contained in the tungsten powder probably moves to the wire rod during firing and makes the wire rod fragile. Accordingly, the somberness can function as an indicator of the easiness of breaking. In the anode body of the present invention, the sintered compact comprises a high-oxygen-affinity metal compact, and oxygen moves from the tungsten powder to the high-oxygen-affinity metal powder in the sintered compact during firing to reduce the amount of oxygen moving to the wire rod. It is presumed that as a result somberness or breaking of the wire rod hardly occurs.

In particular, the anode body prepared as described above can be preferably used as the anode body for an electrolytic capacitor. The electrolytic capacitor using the anode body can be produced by a known method. For example, the sintered compact is immersed in a chemical conversion solution with pinching the wire rod implanted in the sintered compact so that the surface of the sintered compact on which the wire rod is implanted is just below the solution surface and then chemically converting the outer surface of the sintered compact and the inner surfaces of the pores into dielectric layers by electrolytic oxidation. The dielectric layers can have a thickness having a desired withstand voltage by regulating the chemical conversion voltage. Examples of the chemical conversion solution include solutions containing acids, such as sulfuric acid, boric acid, oxalic acid, adipic acid, phosphoric acid, nitric acid or the like, or electrolytes, such as alkali metal salts or ammonium salts of these acids. The chemical conversion solution may contain an oxidizing agent that can provide oxygen, such as hydrogen peroxide, ozone or the like, within a range that does not impair the effects of the present invention. Preferred examples of the oxidizing agent include persulfate compounds, such as ammonium persulfate, potassium persulfate, potassium hydrogen persulfate or the like. These oxidizing agents may be used alone or in combination of two or more.

The component prepared by the above-described chemical conversion treatment is rinsed with pure water and is then dried. The drying may be performed at any temperature for any period of time that allows the water adhering to the component to be evaporated. In the drying, heat treatment may be performed. The heat treatment is performed at preferably not higher than 250° C. and more preferably at 160° C. to 230° C. After the heat treatment, chemical conversion treatment may be performed again. The additional chemical conversion treatment can be performed under the same conditions as those in the first chemical conversion treatment. After the additional chemical conversion treatment, rinse with pure water and drying can be performed as described above.

The component prepared by the above-described method is equipped with a cathode. The cathode may be any cathode that is used in various types of solid electrolytic capacitors. The cathode may be, for example, an inorganic or organic semiconductor layer. Examples of the organic semiconductor layer include layers of electroconductive polymers such as polythiophene derivatives or the like. The organic or inorganic semiconductor layer is formed not only on the outer surface of the sintered compact but also on the inner walls of the pores in the sintered compact. On the organic or inorganic semiconductor layer may be further formed a carbon paste layer, silver paste layer, metal plating layer or the like.

The cathode is electrically connected to a cathode lead, which is exposed to the outside of the package of the electrolytic capacitor to become a cathode external terminal. The anode is electrically connected to an anode lead via the wire rod (anode lead wire) implanted in the sintered compact, and the anode lead is exposed to the outside of the package of the electrolytic capacitor to become an anode external terminal. The cathode lead and the anode lead can be attached by means of ordinary lead frames. Subsequently, the package is formed by sealing with, for example, a resin to give an electrolytic capacitor. The thus-produced electrolytic capacitor can be subjected to aging treatment if desired. The thus-prepared electrolytic capacitor can be applied to various electronic circuits and electric circuits.

### EXAMPLES

The present invention will now be more specifically described by Examples. The followings are merely examples for explanation, and the present invention is not limited to them.

Evaluation was made by the following methods in Examples.

(Number of Somberness)

Somberness at the bases of the implanted lead wires of randomly selected 50 anode bodies was investigated by the naked eye. The number of the anode bodies colored to dull white was defined as the “number of somberness”.

(Number of Breaking)

A nickel wire having a cross section of 0.5 mm square was arranged at the base of an implanted lead wire so as to be orthogonal to the lead wire. The lead wire was bent at the position of the nickel wire by 90 degrees. Subsequently, the lead wire was returned to the position before the bending. This bending operation was performed three times. Randomly selected 50 anode bodies were subjected to the three bending operations, and the number of the anode bodies of which lead wires were broken during the operations was defined as the “number of breaking”.

(Elemental Analysis)

The contents of elements in an anode body were determined with ICPS-8000E (manufactured by Shimadzu Corporation) by ICP emission analysis. The amounts of nitrogen and oxygen in the anode body were each determined with an oxygen/nitrogen analyzer (TC600, manufactured by LECO Corporation) by a thermal conductivity method and an infrared absorption method. The average of the measured values of randomly selected three anode bodies was calculated.

(Average Primary Particle Diameter)

The average primary particle diameter was determined by measuring the particle diameters of randomly selected 30 primary particles in an image taken with a scanning electron microscope (SEM) at a magnification of 100000 times and calculating the average of the measured values based on the number.

### Example 1

Tungsten oxide was reduced with hydrogen to prepare a tungsten powder having an average primary particle diameter of 93 nm, and the tungsten powder was fired, pulverized, and sieved to obtain a granulated tungsten powder having a particle diameter range of 10 to 320 μm.

Potassium fluorotantalate was reduced with sodium to prepare a tantalum powder having an average primary particle diameter of 90 nm, and the tantalum powder was fired, pulverized, and sieved to obtain a granulated tantalum powder having a particle diameter range of 26 to 53 μm. The oxygen content of the granulated tantalum powder was 1.1% by mass.

The granulated tungsten powder was mixed with 0.1% by mass of the granulated tantalum powder to prepare a powder mixture. The powder mixture was compressed to form a compact with a tantalum wire (commercial product) having a diameter of 0.29 mm planted therein as a lead wire. The compact was fired under vacuum at 1300° C. for 30 minutes for sintering to produce a sintered compact, as an anode body, of 1.0 mm×1.5 mm×4.5 mm having the lead wire of 13.7 mm length implanted in the 1.0 mm×1.5 mm surface of the sintered compact such that 3.7 mm of the lead wire was buried inside the sintered compact and 10 mm of the lead wire was exposed to the outside of the sintered compact. Thus, 100 anode bodies were produced.

The number of somberness and the number of breaking of the lead wires of 50 anode bodies randomly selected from the produced 100 anode bodies were measured. The results are shown in Table 1.

### Examples 2 to 5 and Comparative Examples 1 and 2

Anode bodies were prepared in the same manner as that in Example 1 except that the amounts of the granulated tantalum powders were those shown in Table 1. The number of somberness and the number of breaking of the lead wires were measured. The results are shown in Table 1.

TABLE 1

| | Ta amount | number of | number of |
|---|---|---|---|
| | [mass %] | somberness | breaking |
| Ex. 1 | 0.1 | 7 | 2 |
| Ex. 2 | 0.5 | 2 | 1 |
| Ex. 3 | 1 | 1 | 0 |
| Ex. 4 | 2 | 1 | 0 |
| Ex. 5 | 3 | 0 | 0 |
| Comp. Ex. 1 | 0 | 50 | 46 |
| Comp. Ex. 2 | 0.05 | 47 | 42 |

### Example 6

A commercially available tungsten powder having an average primary particle diameter of 0.6 μm was mixed with 0.1% by mass of a commercially available silicon powder having an average primary particle diameter of 1 μm. The mixture was heated under vacuum at 1450° C. for 30 minutes and was then cooled to room temperature, pulverized, and sieved to obtain a granulated tungsten powder (part of silicon bonded to tungsten in part of the surface) having a particle diameter range of 26 to 180 μm.

Potassium fluorotantalate was reduced with sodium to prepare a tantalum powder having an average primary particle diameter of 0.7 μm, and the tantalum powder was fired, pulverized, and sieved to obtain a granulated tantalum powder having a particle diameter range of 53 to 75 μm. The oxygen content of the granulated tantalum powder was 0.35% by mass.

The granulated tungsten powder was mixed with 0.1% by mass of the granulated tantalum powder to prepare a powder mixture. The powder mixture was compressed to form a compact with a tantalum wire (commercial product: crystallization preventive wire blended with a small amount of yttrium) having a diameter of 0.29 mm planted therein as a lead wire. The compact was fired under vacuum at 1500° C. for 30 minutes for sintering to produce a sintered compact, as an anode body, of 1.0 mm×1.5 mm×4.5 mm having the lead wire of 13.7 mm length implanted in the 1.0 mm×1.5 mm surface of the sintered compact such that 3.7 mm of the lead wire was buried inside the sintered compact and 10.0 mm of the lead wire was exposed to the outside of the sintered compact. Thus, 100 anode bodies were produced. The number of somberness and the number of breaking of the lead wires of 50 anode bodies randomly selected from the produced 100 anode bodies were measured. The results are shown in Table 2.

### Examples 7 to 10 and Comparative Examples 3 and 4

Anode bodies were prepared in the same manner as that in Example 6 except that the amounts of the granulated tantalum powders were those shown in Table 2. The number of somberness and the number of breaking of the lead wires were measured. The results are shown in Table 2.

TABLE 2

| | Ta amount | number of | number of |
|---|---|---|---|
| | [mass %] | somberness | breaking |
| Ex. 6 | 0.1 | 5 | 1 |
| Ex. 7 | 0.5 | 2 | 0 |
| Ex. 8 | 1 | 1 | 0 |
| Ex. 9 | 2 | 1 | 0 |
| Ex. 10 | 3 | 0 | 0 |
| Comp. Ex. 3 | 0 | 42 | 36 |
| Comp. Ex. 4 | 0.05 | 40 | 33 |

### Example 11

A niobium ingot was pulverized in hydrogen to prepare a niobium powder having an average primary particle diameter of 0.5 μm. The niobium powder was granulated under vacuum, pulverized, and sieved to obtain a granulated niobium powder having a particle diameter range of 53 to 75 μm. The oxygen content of the granulated niobium powder was 1.8% by mass.

A granulated tungsten powder prepared in the same manner as that in Example 6 was mixed with 0.1% by mass of the granulated niobium powder to prepare a powder mixture. The powder mixture was compressed to form a compact with a niobium wire (prepared from a niobium ingot by sequentially thinning it with a die) having a diameter of 0.29 mm planted therein as a lead wire. The compact was fired under vacuum at 1450° C. for 30 minutes for sintering to produce a sintered compact, as an anode body, of 1.0 mm×1.5 mm×4.5 mm having the lead wire of 13.7 mm length implanted in the 1.0 mm×1.5 mm surface of the sintered compact such that 3.7 mm of the lead wire was buried inside the sintered compact and 10.0 mm of the lead wire was exposed to the outside of the sintered compact. Thus, 100 anode bodies were produced. The number of somberness and the number of breaking of the lead wires of 50 anode bodies randomly selected from the produced 100 anode bodies were measured. The results are shown in Table 3.

### Examples 12 to 15 and Comparative Examples 5 and 6

Anode bodies were prepared in the same manner as that in Example 11 except that the amounts of the granulated niobium powders were those shown in Table 3. The number of somberness and the number of breaking of the lead wires were measured. The results are shown in Table 3.

TABLE 3

| | Nb amount | number of | number of |
|---|---|---|---|
| | [mass %] | somberness | breaking |
| Ex. 11 | 0.1 | 8 | 3 |
| Ex. 12 | 0.5 | 3 | 1 |
| Ex. 13 | 1 | 2 | 0 |
| Ex. 14 | 2 | 1 | 0 |
| Ex. 15 | 3 | 0 | 0 |
| Comp. Ex. 5 | 0 | 44 | 40 |
| Comp. Ex. 6 | 0.05 | 37 | 35 |

### Example 16

A niobium ingot was pulverized in hydrogen to prepare a niobium powder having an average primary particle diameter of 0.5 μm. The niobium powder was placed in a nitrogen gas containing 3% by volume of oxygen at 230° C. for oxidation. The oxidized niobium powder was granulated under vacuum, pulverized, and sieved to obtain a granulated niobium powder having a particle diameter range of 53 to 75 μm. The oxygen content of the granulated niobium powder was 2.3% by mass.

An anode body was prepared as in Example 15 except that the granulated niobium powder used in Example 15 was changed to the granulated niobium powder prepared in Example 16. The number of somberness and the number of breaking of the lead wires were measured. The number of somberness was 26, and the number of breaking was 14.

1. An anode body for a capacitor, the anode body comprising:
a sintered compact comprising tungsten and a high-oxygen-affinity metal; and
a wire rod partially embedded in the sintered compact, wherein
the high-oxygen-affinity metal has an oxygen affinity higher than that of tungsten, the content of the high-oxygen-affinity metal in the sintered compact is 0.1 to 3% by mass based on the mass of the tungsten in the sintered compact; and
the wire rod comprises tantalum or niobium.

2. The anode body according to claim 1, wherein the high-oxygen-affinity metal is a valve action metal.

3. The anode body according to claim 1, wherein the high-oxygen-affinity metal is at least one selected from the group consisting of tantalum, niobium, titanium, and aluminum.

4. The anode body according to claim 1, wherein the sintered compact further comprises silicon.

5. The anode body according to claim 4, wherein the amount of the silicon in the sintered compact is 0.05 to 7% by mass based on the mass of the tungsten in the sintered compact.

6. A method for producing an anode body for a capacitor, the method comprising:
compressing a powder mixture comprising a tungsten powder and a high-oxygen-affinity metal powder into a compact with a wire rod planted therein; and
firing the compact into a sintered compact, wherein
the high-oxygen-affinity metal has an oxygen affinity higher than that of tungsten;
the content of the high-oxygen-affinity metal powder in the powder mixture is regulated so that the content of the high-oxygen-affinity metal in the sintered compact is 0.1 to 3% by mass based on the mass of the tungsten in the sintered compact; and
the wire rod comprises tantalum or niobium.

7. The method for producing the anode body according to claim 6, wherein the powder mixture further comprises a silicon powder.

8. The method for producing the anode body according to claim 6, wherein the high-oxygen-affinity metal powder has an oxygen content of not more than 3% by mass.

9. The method for producing the anode body according to claim 6, wherein the high-oxygen-affinity metal powder has an average primary particle diameter twice or less that of the tungsten powder.

10. The method for producing the anode body according to claim 6, wherein
the powder mixture is prepared by mixing a granulated high-oxygen-affinity metal powder prepared by firing and pulverizing the high-oxygen-affinity metal powder and a granulated tungsten powder prepared by firing and pulverizing the tungsten powder; and
the granulated high-oxygen-affinity metal powder has a particle size distribution range within a range of the particle size distribution of the granulated tungsten powder, or the granulated high-oxygen-affinity metal powder has a maximum particle diameter twice or less that of the granulated tungsten powder.

11. A capacitor comprising the anode body according to claim 1.
